(19) United States
(12) Patent Application Publication
(10) Pub. No.: US 2025/0356391 A1
(43) Pub. Date: Nov. 20, 2025

(54) NON-TRANSITORY COMPUTER READABLE STORAGE MEDIUM, SERVER, AND LABEL DATA SHARING SYSTEM

(71) Applicant: BROTHER KOGYO KABUSHIKI KAISHA, Nagoya (JP)

(72) Inventor: Tetsuya Nose, Nagoya (JP)

(21) Appl. No.: 19/281,494

(22) Filed: Jul. 25, 2025

Related U.S. Application Data
(63) Continuation of application No. PCT/JP2024/002787, filed on Jan. 30, 2024.

(30) Foreign Application Priority Data
Feb. 3, 2023 (JP) 2023-015625

(51) Int. Cl. G06Q 30/0226; G06F 3/12

(52) U.S. Cl. CPC G06Q 30/0226; G06F 3/1203; G06F 3/1273; G06F 3/1287; G06F 3/1289

(57) ABSTRACT

A non-transitory computer readable storage medium stores a program configured to be executed by a server. The server being configured to access a points database storing held points for each user ID. The held points being points held by a user. The program comprising instructions which, when executed by the server, cause a computer of the server to execute upload acceptance processing of accepting a user ID and an upload instruction of label data from a first information processing device, the label data being data configured to be printed by a label printer.

### REFERENCE TO RELATED APPLICATIONS

This is a continuation application of International Application No. PCT/JP2024/002787 filed on Jan. 30, 2024, which claims priority from Japanese Patent Application No. 2023-015625 filed on Feb. 3, 2023. The entire contents of the aforementioned applications are incorporated herein by reference.

### BACKGROUND ART

In the related art, as a system for sharing content data, a system is known in which a server for storing content data is prepared on the Internet, content data is posted from a device of a user, that is, uploaded to the server, and the content data is downloaded to a device of another user. In such a system, in order to promote posting of content data, a user who has posted content data may be granted points available in the system.

In a points management system disclosed in a related art, when photograph data is uploaded from a PC of a user A to a WWW server, and the photograph data is purchased and downloaded from the WWW server by a PC of a user B, points corresponding to a purchase amount are added to the user B as the purchaser, and points corresponding to the data size of the photograph data are added to the user A as the poster when the photograph data is uploaded or downloaded.

In recent years, a system for sharing label data used for printing a label in a label printer has been studied. In such a system, the points granted to the poster are also compensation for the use of the label printer. However, the label data being uploaded or downloaded does not mean that the label printer is used unless the label data is printed.

Although it can be expected that the poster is motivated to create label data by granting points at the timing of uploading or downloading the data as disclosed in the related art, the points granted to the poster do not necessarily constitute compensation for promoting the use of the label printer. Therefore, another mechanism for determining points to be granted to the poster is desired.

### SUMMARY

A non-transitory computer readable storage medium storing a program configured to be executed by a server,
the server being configured to access a points database storing held points for each user ID,
the held points being points held by a user,
the program comprising instructions which, when executed by the server, cause a computer of the server to execute:
   upload acceptance processing of accepting a user ID and an upload instruction of label data from a first information processing device, the label data being data configured to be printed by a label printer,
in which in a case where the computer accepts the upload instruction of the label data in the upload acceptance, the instructions further cause the computer of the server to execute:
   reception processing of receiving posted label data that is the label data uploaded from the first information processing device; and
   storage processing of storing the posted label data received in the reception in association with the user ID accepted in the upload acceptance processing,
the instructions further cause the computer of the server to execute:
   download acceptance processing of accepting a download instruction of the posted label data from a second information processing device,
in a case where the computer accepts the download instruction in the download acceptance processing, the instruction further causes the computer of the server to execute transmission processing of transmitting the posted label data to the second information processing device,
in a case where the posted label data is printed by a label printer according to an instruction from the second information processing device, a printing log is output from the second information processing device, the printing log including identification information for identifying the printed posted label data, and
the instruction further cause the computer of the server to execute:
   acquisition processing of acquiring the printing log;
   determination processing of determining obtained points based on the printing log acquired in the acquisition processing, the obtained points being points granted by printing specific posted label data, specific posted label data being the posted label data identified by the identification information; and
   addition processing of accessing the points database to add the obtained points determined in the determination processing to the held points corresponding to the user ID associated with the specific posted label data.

### BRIEF DESCRIPTION OF DRAWINGS

FIG. 1 is a diagram schematically illustrating a label data sharing system according to the present embodiment.

FIG. 2A is a schematic diagram illustrating an electrical configuration of a label management server.

FIG. 2B is a schematic diagram illustrating an electrical configuration of a printing log server.

FIG. 3A is a diagram illustrating an example of user related information stored in a user database.

FIG. 3B is a diagram illustrating an example of posted label related information stored in a posted label database.

FIG. 3C is a diagram illustrating an example of printing log related information stored in a printing log database.

FIG. 4 is a sequence diagram illustrating an example of a procedure of a process of the post of a label provided to a user by a label management server program of a label management server, including an operation of a client application of a terminal.

FIG. 5 is a diagram schematically illustrating the terminal when newly posting a label.

FIG. 6 is a sequence diagram illustrating an example of a procedure of label download provided to the user by the label management server program of the label management server, including operations of a printer application of a printer, a client application of a terminal, and a printing log server program of the printing log server.

FIG. 7 is a sequence diagram illustrating an example of a procedure of label download provided to the user by the label management server program of the label management server, including operations of the printer application of the printer, the client application of the terminal, and the printing log server program of the printing log server according to a second embodiment.

### DESCRIPTION

### First Embodiment

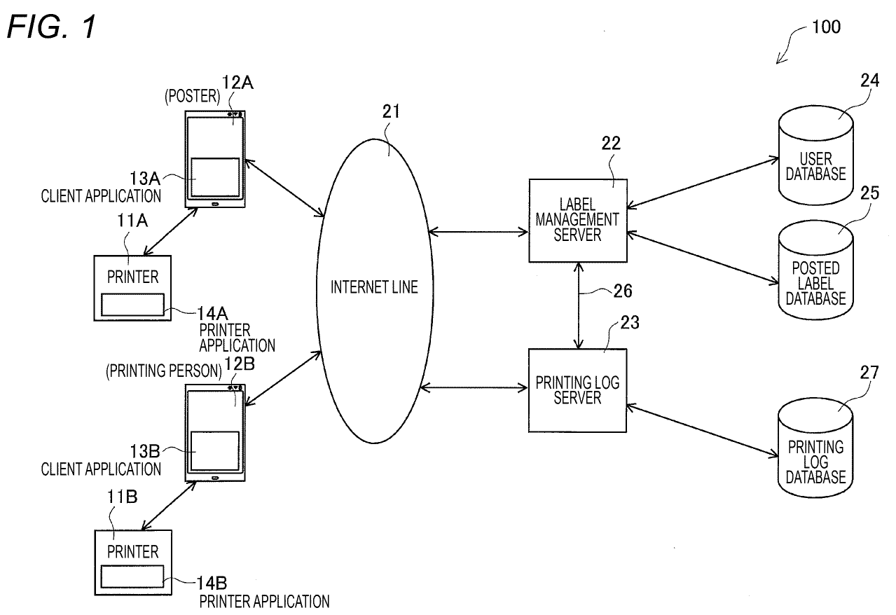

Hereinafter, an embodiment of a label data sharing system 100 according to the present embodiment will be described in detail with reference to the drawings. FIG. 1 is a diagram schematically illustrating the label data sharing system 100.

That is, as illustrated in FIG. 1, the label data sharing system 100 according to the present embodiment is a system provided to the user by the vendors (manufacturer) of a printer 11A and a printer 11B. In the label data sharing system 100 according to the present embodiment, the owner or the user of the printer 11A and the printer 11B can post, that is, upload to a label management server 22, the label data printed by the printer 11A and the printer 11B from a terminal 12A and a terminal 12B. Further, in the label data sharing system 100 according to the present embodiment, the users of the printer 11A and the printer 11B can download the label data from the label management server 22 to the terminal 12A and the terminal 12B, and then create a label by performing printing based on the label data using the printer 11A and the printer 11B connected to the terminal 12A and the terminal 12B. The terminal 12A and the terminal 12B are examples of an information processing device. The printer 11A and the printer 11B are examples of a label printer.

The terminal 12A and the terminal 12B are implemented with a smartphone owned by the user, and may be implemented with tablets or personal computers. Further, the terminal 12A and the terminal 12B is configured to store client applications 13A and 13B provided to users by the vendors of the printer 11A and the printer 11B. The client applications 13A and 13B have a function of creating and editing a label on the terminal 12A and the terminal 12B. The client applications 13A and 13B have a function of uploading the created label data to the label management server 22. In addition, the client applications 13A and 13B have a function of downloading label data from the label management server 22. The client applications 13A and 13B have a function of printing the label data created on the terminal 12A and the terminal 12B and the downloaded label data using the printer 11A and the printer 11B. The printer 11A and the printer 11B may be collectively referred to as a “printer 11” if it is not particularly necessary to distinguish them. In addition, the terminal 12A and the terminal 12B may be collectively referred to as a “terminal 12” if it is not particularly necessary to distinguish them. The client applications 13A and 13B may be collectively referred to as a “client application 13” if it is not particularly necessary to distinguish them.

The printers 11A and 11B store printer applications 14A and 14B for performing printing control of the printers 11A and 11B. The printer 11 is a label printer capable of printing a label, and may be an inkjet printer or a laser printer. The printer 11 is connected to the terminal 12 by wireless LAN communication such as Wi-Fi (registered trademark) or short-range wireless communication such as Bluetooth (registered trademark). The printer 11 and the terminal 12 may be connected by wire using a USB communication standard.

Next, to describe the label management server 22 and the printing log server 23 constituting the label data sharing system 100 according to the present embodiment, the label management server 22 and the printing log server 23 are connected to each of a large number of terminals 12 via an Internet line 21. The label management server 22 and the printing log server 23 may be connected via the Internet line 21 or a wired LAN line 26. A user database 24 and a posted label database 25 are connected to the label management server 22 in an accessible manner. A printing log database 27 is connected to the printing log server 23 in an accessible manner.

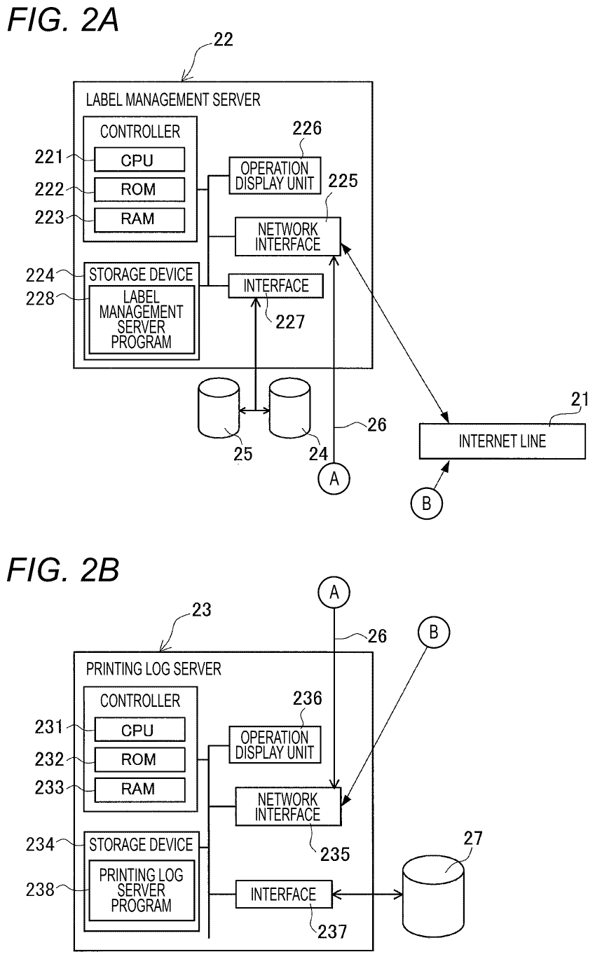

As illustrated in FIG. 2A, the label management server 22 includes a CPU 221, a ROM 222, a RAM 223, a storage device 224, a network interface 225, an operation display unit 226, and an interface 227. The ROM 222 stores an activation program for activating the label management server 22 and the like. The RAM 223 is used as a work area when various types of processing are executed, or as a storage area for temporarily storing data.

The storage device 224 includes, for example, an HDD, or a flash memory, and stores a label management server program 228 and various types of processing programs.

The CPU 221 executes various types of processing in accordance with programs read from the ROM 222 or the storage device 224.

In the present embodiment, the network interface 225 is implemented with an interface of a wired LAN communication standard. In addition, the network interface 225 may be, for example, an interface of a wireless LAN communication standard such as Wi-Fi (registered trademark), an interface of a USB communication standard, or an interface of a short-range wireless communication standard such as Bluetooth (registered trademark). The network interface 225 is connected to the Internet line 21.

The operation display unit 226 includes, for example, a display device and a touch panel disposed on the display device. The display device is configured to display necessary information, and the touch panel is configured to accept an input from a user.

In the present embodiment, the interface 227 is implemented with an interface of a wired LAN communication standard, and is connected to the user database 24 and the posted label database 25. The user database 24 and the posted label database 25 may be included in the label management server 22.

As illustrated in FIG. 2B, the printing log server 23 includes a CPU 231, a ROM 232, a RAM 233, a storage device 234, a network interface 235, an operation display unit 236, and an interface 237. The ROM 232 stores an activation program for activating the printing log server 23 and the like. The RAM 233 is used as a work area when various types of processing are executed, or as a storage area for temporarily storing data.

The storage device 234 includes, for example, an HDD, or a flash memory, and stores a printing log server program 238 and various types of processing programs.

The CPU 231 executes various types of processing in accordance with programs read from the ROM 232 or the storage device 234.

In the present embodiment, the network interface 235 is implemented with an interface of a wired LAN communication standard. In addition, the network interface 235 may be, for example, an interface of a wireless LAN communication standard such as Wi-Fi, an interface of a USB communication standard, or an interface of a short-range wireless communication standard such as Bluetooth. The network interface 235 is connected to the network interface 225 of the label management server 22 via the wired LAN line 26.

The operation display unit 236 includes, for example, a display device and a touch panel disposed on the display device. The display device is configured to display necessary information, and the touch panel is configured to accept an input from a user.

In the present embodiment, the interface 237 is implemented with an interface of a wired LAN communication standard, and is connected to the printing log database 27. The printing log database 27 may be included in the printing log server 23.

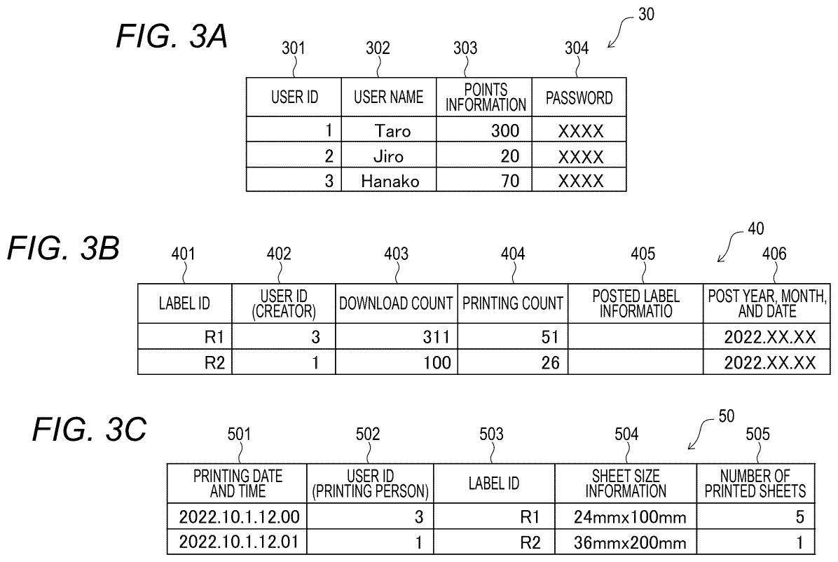

The user database 24 stores user related information 30 illustrated in FIG. 3A as a table. The user related information 30 includes a user ID 301, a user name 302, points information 303, and a password 304 for each user.

The user ID 301 is identification information for identifying a user provided with the label data sharing system 100 according to the present embodiment, and specifies a user who uses the terminal 12. The user name 302 is a name, a nickname, an address, contact information, an e-mail address, or the like of an individual or an organization (corporation) of a user provided with the label sharing service according to the present embodiment. When a label is posted for the first time using the label data sharing system 100 according to the present embodiment, a user ID for specifying a user who posts the label is newly set and additionally stored in the user ID 301. At the time of posting, the user name or the like input by the user on the terminal 12 is additionally stored in the user name 302 corresponding to the newly set user ID.

The points information 303 is information indicating held points, which are points in the label data sharing system 100 of the present embodiment and which are points currently held by the user. The held points can be used instead of cash when using the label data sharing system 100 according to the present embodiment to purchase a printing sheet or the like. The password 304 is a password set by each user stored in the user name 302.

The posted label database 25 is configured to store posted label related information 40 illustrated in FIG. 3B as a table. The posted label related information 40 includes, for each piece of label data posted in the label data sharing system 100 according to the present embodiment, a label ID 401, a user ID 402, a download count 403, a printing count 404, posted label data 405, a post year, month, and date 406, and the like.

The label ID 401 is a serial number sequentially assigned to each label data registered in the posted label database 25 in the label data sharing system 100 according to the present embodiment. The user ID (creator) 402 is a user ID 301 of a user who posts the label data using the label data sharing system 100 according to the present embodiment. The download count 403 is the download count of label data posted by the user. The printing count 404 is the printing count of label data posted by the user. The posted label data 405 is label data that is posted, and is data indicating the configuration of a label. The post year, month, and date 406 is the year, moth and date when the label data is posted by the user. The label ID stored in the label ID 401 is an example of identification information.

The printing log database 27 is configured to store printing log related information 50 illustrated in FIG. 3C as a table. The printing log related information 50 includes a printing date and time 501, a user ID (printing person) 502, a label ID 503, sheet printing size information 504, and the number of printed sheets 505.

The printing date and time 501 is a date and time when the label is printed by the printer 11 in the label data sharing system 100 according to the present embodiment. The user ID (printing person) 502 is the user ID 301 of a user who has printed a label by the printer 11. The label ID 503 is the label ID 401 of the label printed by the printer 11. The sheet printing size information 504 is printing size information on the printing sheet (label) when the user performs printing using the printer 11 in the label data sharing system according to the present embodiment, that is, the printing sheet width and length as in the present embodiment. The number of printed sheets 505 is the number of printed sheets of the labels printed by the printer 11.

### (Post of Label)

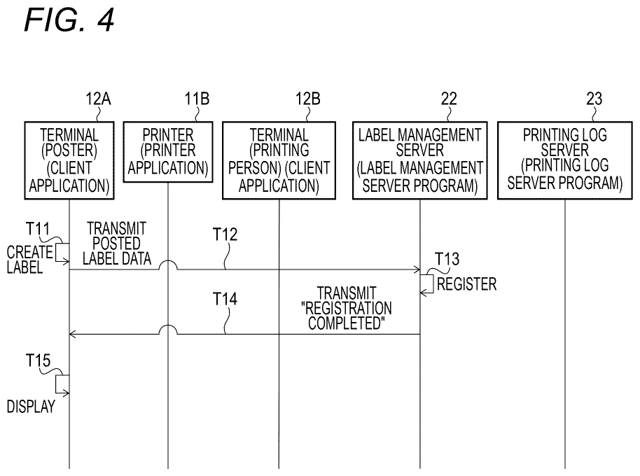

Next, an example of a procedure of the post of label data executed by the label management server program 228 of the label management server 22 including an operation of the client application 13 of the terminal 12 according to the present embodiment will be described with reference to a sequence diagram of FIG. 4.

Processing steps in the present embodiment basically indicate processing of the CPU 221 according to instructions mainly described in programs such as the label management server program 228. The processing by the CPU 221 also include hardware control using APIs of the OS. In the present specification, a detail description of the OS is omitted, and an operation of each program is described.

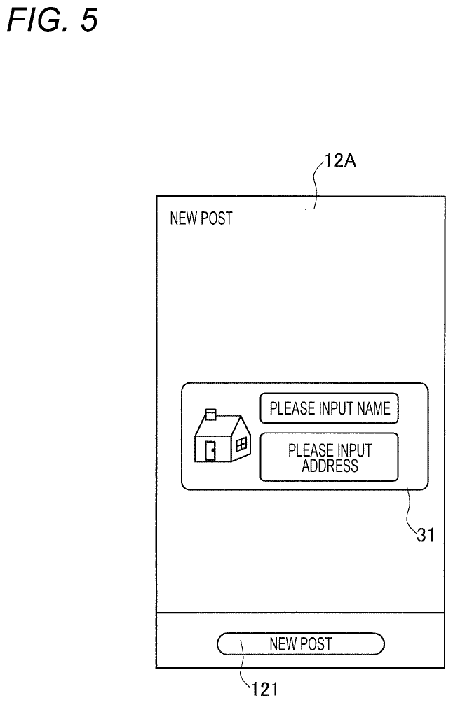

In the label post according to the present embodiment, first, a user (hereinafter, referred to as a poster) who intends to execute post of label data activates the client application 13A of the terminal (poster) 12A, and then creates label data on the label 31 as illustrated in FIG. 5 on the terminal (poster) 12A (procedure 11 (hereinafter, referred to as T11)).

Thereafter, when the poster touches a “new posting” button 121 displayed on the terminal (poster) 12A, the client application 13A of the terminal (poster) 12A transmits, to the label management server 22, the user ID of the poster, posted label data which is label data created by the poster, sheet size information suitable for printing the posted label data, and the like (T12). For example, the label management server program 228 provides a web page for posting, the web page is displayed by a browser function of the client application 13A, the user ID is input when logging in to the label management server 22 via the web page, and then an instruction to transmit the posted label data is input via the web page, so that the posted label data and the sheet size information are uploaded to the label management server 22. The posted label data is an example of label data.

Then, upon receiving the posted label data and the like transmitted from the terminal (poster) 12A, the label management server 22 stores the received posted label data and the like in the posted label database 25 (T13). This processing is an example of reception processing.

Specifically, the label management server 22 creates a new label ID and stores the new label ID in the posted label database 25 as a new label ID 401 of the posted label related information 40. Thereafter, in the table of the posted label related information 40 corresponding to the new label ID 401, the received user ID 301 of the poster is stored as the user ID (creator) 402, the received posted label data is stored as the posted label data 405, and the year, month, and date of the post date is stored as the post year, month, and date 406. This processing is an example of storage processing.

Next, the label management server 22 transmits “registration complete” to the terminal (poster) 12A (T14). Then, upon receiving “registration complete”, the terminal (poster) 12A displays that the registration of the posted label is complete on the display unit thereof, and notifies the poster (T15). Accordingly, the poster can know that the posted label data has been registered in the label data sharing system.

### (Download Processing of Label Data)

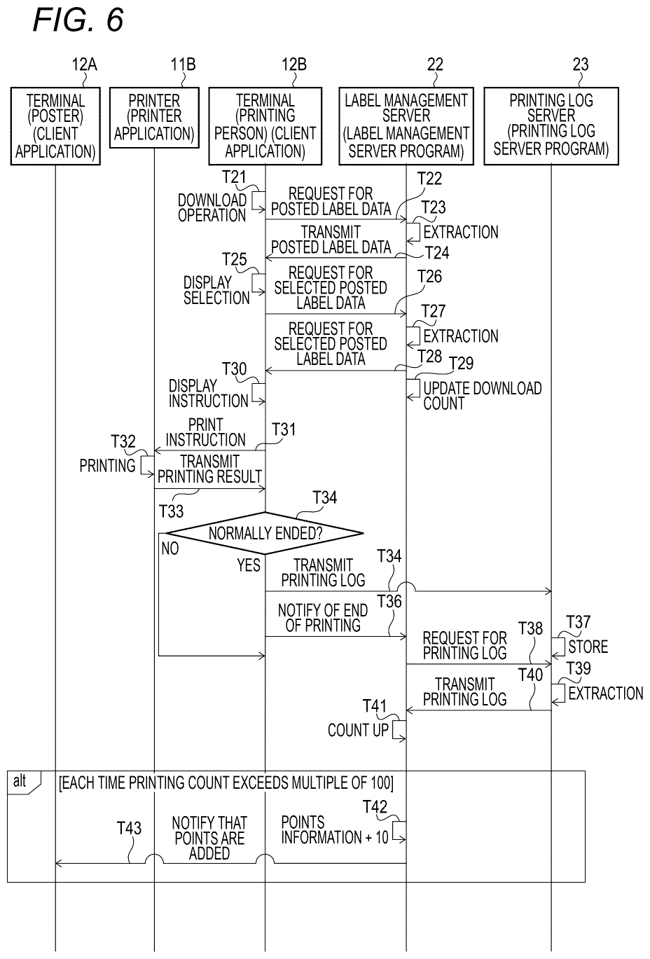

Next, an example of a procedure of download processing of the label data provided to the user by the label management server program 228 of the label management server 22 including operations of the printer applications 14A and 14B of the printers 11A and 11B, the client application 13 of the terminal 12, and the printing log server program 238 of the printing log server 23 according to the present embodiment will be described with reference to a sequence diagram of FIG. 6.

In the download processing of the posted label data according to the present embodiment, first, when a user who intends to execute download of the posted label data (hereinafter, referred to as a printing person) activates the client application 13B of the terminal (printing person) 12B and then touches a “label download” button (not illustrated) displayed on the terminal (printing person) 12B (T21), the terminal (printing person) 12B requests the label management server 22 for the posted label data (T22). For example, the label management server program 228 provides a login web page, the web page is displayed by the browser function of the client application 13B, and the user ID is input via the web page, thereby transmitting the user ID. When the login is approved, the label management server 22 accepts the request for the posted label data.

Next, upon accepting the request for the posted label data, the label management server 22 extracts the posted label data stored as the posted label data 405 from the posted label database 25 together with the label ID stored as the label ID 401 (T23). At this time, when a plurality of pieces of posted label data are stored as the posted label data 405, the label management server 22 extracts the plurality of pieces of posted label data and label IDs. The posted label data extracted at this time may be thumbnail image data of a label. Thereafter, the label management server 22 transmits, to the terminal (printing person) 12B, the extracted posted label data together with the label ID and the like (T24).

Next, upon receiving the posted label data and the label ID, the terminal (printing person) 12B displays the received posted label data on the display unit of the terminal (printing person) 12B. For example, the label management server program 228 provides a web page for selecting the posted label data, the web page is displayed by the browser function of the client application 13B, and the posted label data is displayed as a list via the web page. Therefore, when the printing person touches an “execute” button (not illustrated) after selecting one of the plurality of pieces of posted label data displayed on the terminal (printing person) 12B (T25), the user ID of the download executor and the label ID of the selected label 31 are input from the terminal (printing person) 12B to the label management server 22, and the download of the selected posted label data is requested (T26).

Then, upon receiving the download request for the posted label data, the label management server 22 extracts the posted label data stored in the posted label data 405 from the posted label database 25, based on the label ID for the requested posted label data (T27). Then, the label management server 22 transmits the extracted posted label data to the terminal (printing person) 12B (T28). Further, the label management server 22 counts up the value of the download count 403 of the posted label related information 40 stored in the posted label database 25 by one, based on the received label ID (T29).

On the other hand, upon receiving the posted label data and the like, the terminal (printing person) 12B displays the received posted label data on the display unit of the terminal (printing person) 12B (T30). In this state, when the printing person touches a “print” button (not illustrated), the terminal (printing person) 12B transmits the posted label data and the like to the printer 11B to instruct printing (T31).

Upon receiving the print instruction, the printer 11B executes the printing of the label 31 based on the received posted label data and the like (T32). Next, upon ending the printing of the label, the printer 11B transmits the printing result to the terminal (printing person) 12B (T33).

Next, upon receiving the printing result, the terminal (printing person) 12B determines whether the printing is normally ended based on the printing result received from the printer 11B (T34). Then, when the printing is normally ended (T34: YES), the terminal (printing person) 12B transmits the printing log to the printing log server 23 (T35), and the terminal (printing person) 12B transmits a printing end notification including the printing date and time, the user ID who executed the printing, and the like to the label management server 22 (T36).

Next, upon receiving the printing log, the printing log server 23 stores the received printing log as a new record (T37). Specifically, the printing date and time included in the printing log is stored as the printing date and time 501, the user ID 301 of the printing person who executed the printing included in the printing log is stored as the user ID (printing person) 502, the label ID 401 of the printed label included in the printing log is stored as the label ID 503, the sheet size of the printed label included in the printing log is stored as the sheet printing size information 504, and the number of printed sheets included in the printing log is stored as the number of printed sheets 505.

On the other hand, upon receiving the printing end notification, the label management server 22 requests the printing log server 23 for the printing log (T38).

Next, upon receiving the request for the printing log, the printing log server 23 searches the printing log database 27 based on the printing date and time included in the printing log request and the user ID 301 who executed the printing, and extracts the label ID, the sheet printing size information, and the number of printed sheets from the hit printing log related information 50 (T39). Then, since the printing log server 23 transmits the extracted information to the label management server 22, the label management server 22 receives the information extracted by the printing log server 23 (T40). The processing of T39 is an example of acquisition processing. The printing log server 23 may search the printing log database 27 based on the printing date and time included in the printing log request and the user ID 301 who executed the printing, and then transmit the searched printing log related information 50 to the label management server 22 without extracting the label ID, the sheet printing size information, and the number of printed sheets, and the label management server 22 may extract the label ID, the sheet printing size information, and the number of printed sheets upon receiving the printing log related information 50.

Next, upon receiving the label ID, the sheet printing size information, the number of printed sheets, and the like, the label management server 22 counts up the value of the printing count 404 of the posted label related information 40 stored in the posted label database 25 by one, based on the received label ID (T41).

At this time, the label management server 22 may add the numerical value counted up to the value of the printing count 404 based on the sheet printing size information and the number of printed sheets included in the received printing log. For example, if the number of printed sheets is five, the value of the printing count 404 may be counted up by a numerical value “5”. If the area of the sheet size is twice the standard size, for example, 12 mm×100 mm, the numerical value counted up of the printing count 404 may be doubled. At this time, the label management server 22 may consider the value of the download count 403 for the numerical value for counting up the value of the printing count 404.

In the present embodiment, if the count-up value is determined in consideration of the value of the download count 403, the motivation of the poster may decrease if no points are added at all unless printed, but it can be expected that the decrease in the motivation of the poster is controlled if the points are also added to the poster when the label data is downloaded. In this case, the points added at the time of downloading may be less than the points added by printing.

Next, based on the received label ID, the label management server 22 determines whether the value of the printing count 404 of the posted label related information 40 stored in the posted label database 25 exceeds a multiple of 100, and increases the value of the points information 303 stored in the user database 24 by 10 points each time of exceeding, that is, each time the posted label data is printed 100 times by the printing person (T42). When the value of the printing count 404 of the posted label related information 40 stored in the posted label database 25 does not exceed a multiple of 100, the value of the points information 303 stored in the user database 24 is not added. The processing of T42 is an example of determination processing and addition processing. The numerical value “100” is an example of a first threshold. 10 points is an example of the predetermined value.

As described above, in the present embodiment, points may be added excessively if the value of the points information 303 is added each time the posted label data is printed. Therefore, appropriate points can be granted by storing the printing count for each piece of posted label data and granting 10 points when the printing count exceeds the numerical value “100”. The numerical value “100” is merely an example, and various values can be adopted depending on the circumstances.

Further, based on the received label ID, the label management server 22 notifies the terminal (poster) 12A that the value of the points information 303 is added each time the value of the printing count 404 of the posted label related information 40 stored in the posted label database 25 exceeds a multiple of 100 (T43).

As described above, in the present embodiment, by notifying that the held points are updated, the poster can immediately understand that the held points are added, and an increase in the motivation of the poster to post the next label data can be expected. Further, in the present embodiment, by immediately granting points to the poster of the posted label data each time the posted label data is printed, it can be expected that the motivation of the poster posting the next label data is immediately increased as compared with a case where the obtained points are determined at any timing.

The present embodiment is configured such that the terminal (poster) 12A is notified that the held points are updated, but may be configured such that, for example, a notification recipient corresponding to the user ID is registered in advance and a notification is pushed to the notification recipient.

### Second Embodiment

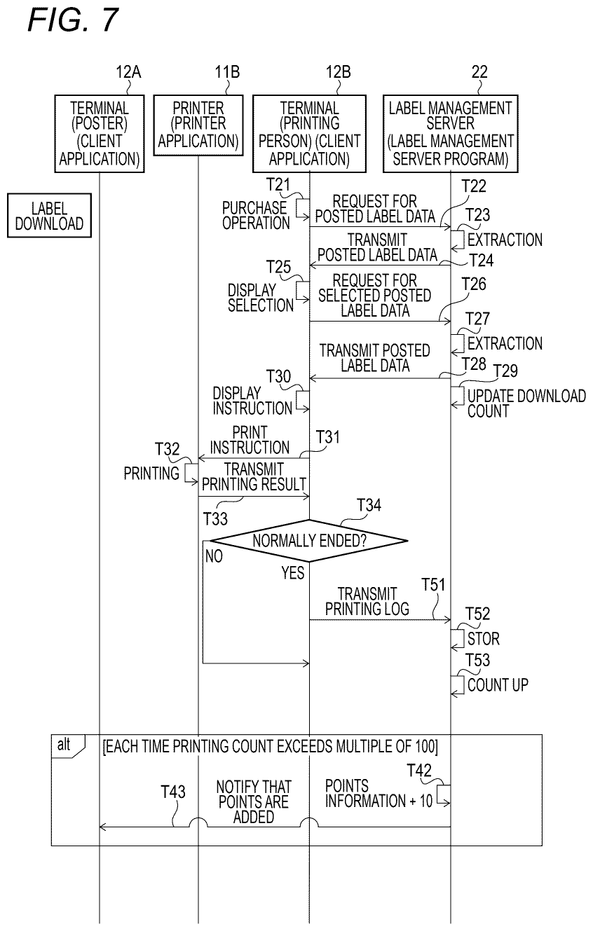

Next, an example of a procedure of label download processing provided to the user by the label management server program 228 of the label management server 22 including operations of the printer applications 14A and 14B of the printer 11 and the client application 13 of the terminal 12 of the present embodiment will be described with reference to a sequence diagram of FIG. 7. In the description, those the same as in the first embodiment are denoted by the same reference signs.

That is, in the first embodiment, the user database 24 and the posted label database 25 are connected to the label management server 22, and the printing log database 27 is connected to the printing log server 23, but in the present embodiment, the user database 24, the posted label database 25, and the printing log database 27 are connected to the label management server 22. Therefore, in the present embodiment, the printing log server 23 in the first embodiment does not exist.

In FIG. 7, upon receiving the printing result, the terminal (printing person) 12B determines whether the printing is normally ended based on the printing result received from the printer 11B (T34). If the terminal (printing person) 12B determines that the printing is normally ended (T34: YES), the terminal (printing person) 12B transmits the printing log to the label management server 22 (T51).

Next, upon receiving the printing log, the label management server 22 stores the received printing log in the printing log database 27 as a new record (T52). Specifically, the printing date and time included in the printing log is stored as the printing date and time 501, the user ID 301 of the printing person who executed the printing included in the printing log is stored as the user ID (printing person) 502, the label ID 401 of the printed label included in the printing log is stored as the label ID 503, the sheet size of the printed label included in the printing log is stored as the sheet printing size information 504, and the number of printed sheets included in the printing log is stored as the number of printed sheets 505.

Further, the label management server 22 counts up the value of the printing count 404 of the posted label related information 40 stored in the posted label database 25 by one, that is, the numerical value “1”, based on the received label ID (T53).

At this time, the label management server 22 may add the numerical value counted up to the value of the printing count 404 based on the sheet printing size information and the number of printed sheets included in the received printing log. For example, if the number of printed sheets is five, the value of the printing count 404 may be counted up by a numerical value “5”. If the area of the sheet size is twice the standard size, for example, 12 mm×100 mm, the numerical value counted up of the printing count 404 may be doubled. At this time, the label management server 22 may consider the value of the download count 403 for the numerical value for counting up the value of the printing count 404.

Next, based on the received label ID, the label management server 22 determines whether the value of the printing count 404 of the posted label related information 40 stored in the posted label database 25 exceeds a multiple of 100, and increases the value of the points information 303 stored in the user database 24 by 10 points each time of exceeding (T42), which is the same as in the first embodiment.

As described above, in the present embodiment, since the printing log server 23 in the first embodiment does not exist, that is, the printing log database 27 is connected to the label management server 22, the label management server 22 does not need to acquire the printing log data via the printing log server 23 as in the first embodiment. That is, since the printing log is directly acquired from the terminal (printing person) 12B, the processing in the label management server 22 is rapid, and the configuration of the entire label data sharing system is simplified as compared with the first embodiment. On the other hand, if a system for collecting printing logs is already constructed, a configuration for collecting posted label data and a configuration for managing points are provided separately from the configuration for collecting printing logs as in the first embodiment, thereby facilitating incorporation into an existing system.

As described above in detail, by granting points to the poster based on the printing log of the posted label data, points are granted for the use of the label printer, thereby granting the poster an appropriate compensation for the use of the label printer.

The embodiments disclosed in the present specification are merely an example, and does not limit the present invention. Therefore, various improvements and modifications can be naturally made to the technique disclosed in the present specification without departing from the gist of the present invention. The number of printers connected to the terminal is not limited to the illustrated example, and may be two or more.

In the present embodiment, the label management server 22 acquires the printing log each time the posted label data is printed, and the value of the points information 303 may be updated, but the obtained points may be determined by collectively reading the printing logs printed during the period at any timing, for example, at the beginning or the end of the month. In this case, the processing load of the server is smaller than that in a configuration in which a printing log is acquired each time printing is performed. The setting of any timing may be performed by the administrator of the server or by the poster.

Further, in the present embodiment, in the processing of T42, the label management server 22 is configured to increase the value of the points information 303 stored in the user database 24 by 10 points each time the value of the printing count 404 of the posted label related information 40 stored in the posted label database 25 exceeds a multiple of 100, but 10 points is merely an example, and various values can be adopted depending on the circumstances.

For example, the label management server 22 may be configured to increase the number of points to be increased in consideration of the sheet printing size information, the number of printed sheets, and the value of the download count 403 included in the received printing log.

In the present embodiment, the user database 24 and the posted label database 25 are connected to the label management server 22 in an accessible manner, and the printing log database 27 is connected to the printing log server 23 in an accessible manner, but the printing log database 27 and the user database 24 or the posted label database 25 may be connected to the printing log server 23 in an accessible manner.

In any sequence diagram disclosed in the embodiments, an execution order of any plurality of processes can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

What is claimed is:

1. A non-transitory computer readable storage medium storing a program configured to be executed by a server,
the server being configured to access a points database storing held points for each user ID,
the held points being points held by a user,
the program comprising instructions which, when executed by the server, cause a computer of the server to execute:
upload acceptance processing of accepting a user ID and an upload instruction of label data from a first information processing device, the label data being data configured to be printed by a label printer,
wherein in a case where the computer accepts the upload instruction of the label data in the upload acceptance processing, the instructions further cause the computer of the server to execute:
reception processing of receiving posted label data that is the label data uploaded from the first information processing device; and
storage processing of storing the posted label data received in the reception processing in association with the user ID accepted in the upload acceptance processing,
the instructions further cause the computer of the server to execute:
download acceptance processing of accepting a download instruction of the posted label data from a second information processing device,
in a case where the computer accepts the download instruction in the download acceptance processing, the instruction further causes the computer of the server to execute transmission processing of transmitting the posted label data to the second information processing device,
in a case where the posted label data is printed by a label printer according to an instruction from the second information processing device, a printing log is output from the second information processing device, the printing log including identification information for identifying the printed posted label data, and
the instruction further cause the computer of the server to execute:
acquisition processing of acquiring the printing log;
determination processing of determining obtained points based on the printing log acquired in the acquisition processing, the obtained points being points granted by printing specific posted label data, specific posted label data being the posted label data identified by the identification information; and
addition processing of accessing the points database to add the obtained points determined in the determination processing to the held points corresponding to the user ID associated with the specific posted label data.

2. The non-transitory computer readable storage medium according to claim 1,
wherein the server is configured to access a printing count database storing a printing count for each piece of the posted label data, and
in the determination processing, the computer is configured to access the printing count database to add the printing count corresponding to the specific posted label data and to set the obtained points to a predetermined value in a case where the added printing count exceeds a first threshold.

3. The non-transitory computer readable storage medium according to claim 1,
wherein in a case where the held points are added in the addition processing, the instructions cause the computer of the server to execute notification processing of notifying the first information processing device of an update of the held points, the first information processing device uploading the specific posted label data.

4. The non-transitory computer readable storage medium according to claim 1,
wherein the server is configured to access a printing log database, the printing log output by the second information processing device is registered to the printing log database, and
in the acquisition processing, the computer is configured to access the printing log database and read the registered printing log to acquire the printing log.

5. The non-transitory computer readable storage medium according to claim 4,
wherein the instructions cause the computer of the server to execute the acquisition processing, the determination processing, and the addition processing at any set timing.

6. The non-transitory computer readable storage medium according to claim 1,
wherein the instructions cause the computer of the server to execute the acquisition processing, the determination processing, and the addition processing each time the printing log is output from the second information processing device.

7. The non-transitory computer readable storage medium according to claim 1,
wherein the server is configured to access a download count database storing a download count for each piece of the posted label data, and
in a case where the computer transmits the posted label data in the transmission processing, the instructions cause the computer of the server to execute:
download addition processing of accessing the download count database to add the download count corresponding to the transmitted posted label data, and of accessing the points database to add the held points corresponding to the user ID associated with the transmitted posted label data in a case where the added download count exceeds a second threshold.

8. A management server for connecting to a first information processing device and a second information processing device via a network,
wherein the server is configured to access a points database storing held points for each user ID, the held points being points held by a user,
the server is configured to execute upload acceptance processing of accepting a user ID and an upload instruction of label data from a first information processing device, the label data being data configured to be printed by a label printer,
in a case where the server accepts the upload instruction of the label data in the upload acceptance processing, the server is further configured to execute:
reception processing of receiving posted label data that is the label data uploaded from the first information processing device; and
storage processing of storing the posted label data received in the reception processing in association with the user ID accepted in the upload acceptance processing,
the server is further configured to execute:
download acceptance processing of accepting a download instruction of the posted label data from a second information processing device,
in a case where the server accepts the download instruction in the download acceptance processing, the server is further configured to execute transmission processing of transmitting the posted label data to the second information processing device,
in a case where the posted label data is printed by a label printer according to an instruction from the second information processing device, a printing log is output from the second information processing device, the printing log including identification information for identifying the printed posted label data, and
the server is further configured to execute:
acquisition processing of acquiring the printing log;
determination processing of determining obtained points based on the printing log acquired in the acquisition, the obtained points being points granted by printing specific posted label data that is the posted label data identified by the identification information; and
addition processing of accessing the points database to add the obtained points determined in the determination to the held points corresponding to the user ID associated with the specific posted label data.

9. A label data sharing system comprising:
a first information processing device;
a second information processing device; and
a server,
wherein the first information processing device and the second information processing device are configured to connect to the server via a network,
the server is configured to store label data in association with a user ID, the label data being data configured to be printed by a label printer,
the first information processing device is configured to upload posted label data to the server in association with the user ID input to the first information processing device, the posted label data being label data of the first information processing device,
the server is configured to store the posted label data uploaded from the first information processing device in association with the user ID associated with the uploaded posted label data, the second information processing device is configured to download the posted label data stored in the server from the server,
in a case where the second information processing device causes a label printer to print the posted label data, the second information processing device outputs a printing log corresponding to the printing, the output printing log including identification information for identifying the printed posted label data,
the server is configured to access a points database storing held points for each user ID, the held points being points held by the user, and
the server is configured to execute:
acquisition processing of acquiring the printing log;
determination processing of determining obtained points based on the printing log acquired in the acquisition processing, the obtained points being points granted by printing specific posted label data, the specific posted label data being the posted label data identified with the identification information; and
addition processing of accessing the points database to add the obtained points determined in the determination processing to the held points corresponding to a user ID associated with the specific posted label data.
